(19) United States
(12) Patent Application Publication
(10) Pub. No.: US 2012/0266235 A1
(43) Pub. Date: Oct. 18, 2012

(54) Method for reconfiguring a peripheral device using a magnetic swipe card

(75) Inventor: Jerry James Majdic, Riverton, WY (US)

(73) Assignee: Pertech Resources, Inc, Riverton, WY (US)

(21) Appl. No.: 13/064,729

(22) Filed: Apr. 12, 2011

(51) Int. Cl. G06F 13/10; G06F 21/00; H04L 9/32

(52) U.S. Cl. 726/19; 710/8

(57) ABSTRACT

A magnetic-stripe card, with an associated card-reader, provides the apparatus supporting a method to change the configuration of a printer, scanner, or, other peripheral device in a stand alone environment or in a networked environment. A network may be defined as “two or more devices communicating”. The method comprises programming the card with selected configuration data, such as character-font selection, serial baud-rate, or, in the case of a scanner, document-rotate, auto-stamp, scan-resolution, duplex-scan ON/OFF, and other parameters. The card may be swiped at a slot in the peripheral device directly, or through a portable reader, or, even from a reader permanently connected within a LAN. Data on the card alerts the device to be reconfigured of its intent by way of resident utility software on the device, and, within the host, if present. When the transaction is accepted, the data is transmitted to the selected device to rewrite selected configuration parameters. Another very useful feature of this method would be the operator's ability, with his or her own personal magstripe card to “customize” the device to his or her preferences, even to disable the device to other operators. The magnetic swipe-card's limited data space is well suited to the small amount of data required for configuration changes, since many of the configuration parameters are only 1 or 2 bits wide.

### CROSS-REFERENCE TO RELATED INVENTIONS

Not Applicable

### STATEMENT REGARDING FEDERALLY SPONSORED RESEARCH OR DEVELOPMENT

Not Applicable

### REFERENCE TO SEQUENCE LISTING, OR A COMPUTER PROGRAM LISTING COMPACT DISC APPENDIX

Not Applicable

### BACKGROUND OF THE INVENTION

Printers, scanners or other peripheral devices typically used in stand-alone, POS, banking environments, or the like, all have the designed-in ability to change certain operating features that meet the operator's needs. Within the device, these features are contained in a small block of memory called configuration data. This data contains information that controls, for example, in printers, the font to be used, serial port baud-rate, which sensors to enable or disable, printer control language select, firmware revision, etc. In a scanner, for, example, the changeable information may be pixel-type, scan resolution, data compression, document size, and other control data. Information not changed, but, also contained in configuration memory, might be serial-number, model #, amount of internal memory.

In earlier days, configuration of peripherals was more hardware-controlled than software-controlled. Important information such as serial-number, model-number, control bits, etc. may have been contained within permanent memory , and, changes were more cumbersome. More sophistication saw methods arise that allowed easier modifications to be made to this data in the field, both through direct button-control, or dip-switches at the device itself. Software implementation of configuration changes across interconnected devices evolved, and, is now the rule. Non-volatile memory (NV Ram) replaced hard memory as the storage place for configuration data. U.S. Pat. Nos. 7,752,345 and 6,112,256 apply configuration data changes to multiple devices simultaneously in large networks. U.S. Pat. Nos. 6,192,436 and 5,835,864 and others disclose smart-cards, as well, to make large configuration or firmware updates to peripheral devices. SD-cards, and USB-flash devices are used similarly. It is evident that these methods used involve large, networked installations and/or the large amount of data to transfer. This invention presents a novel, simple, method to execute small data transfers to a configurable/re-configurable device. The method is attractive to very small installations, uses existing technology, and, very often uses existing hardware, to configure/reconfigure peripherals.

### BRIEF SUMMARY OF THE INVENTION

The object of this invention is to present a novel method of reconfiguring a printer, scanner, or other peripheral device with a magnetic swipe card. The preferred embodiment is where the magnetic-card reader is actually a part of the peripheral device. Other embodiments within the scope of the invention include a portable card-reader, plugged into a communication port on the device itself, and, additionally, a card-reader that is part of a network of connected peripheral devices. A network is as simple as “two or more devices communicating”, wired and wireless, and, a network may be as large as a cellular environment with an enormous number of communicating devices, wired and wireless.

The magnetic-swipe card can be physically compared to a standard credit-card, but, with different data written onto the stripe. In this invention , the peripheral's configuration parameters, all or just some of them, can be written onto the card and allow the operator to easily and cheaply reconfigure his device, with minimum host involvement. Non-configuration parameters, such as security access to a device itself, are also within the scope of this invention.

### BRIEF DESCRIPTION OF THE SEVERAL VIEWS OF THE DRAWING

FIG. 1 Example Magnetic-stripe card data & graphics layout.

FIG. 2 More Examples, Magnetic-stripe card data & graphics layout.

FIG. 3 A magnetic-stripe card backside with stripe layout.

FIG. 4 Block Diagram—Typical peripheral device with integral reader.

FIG. 5 Typical POS System with Independent Card-Reader.

### DETAILED DESCRIPTION OF THE INVENTION

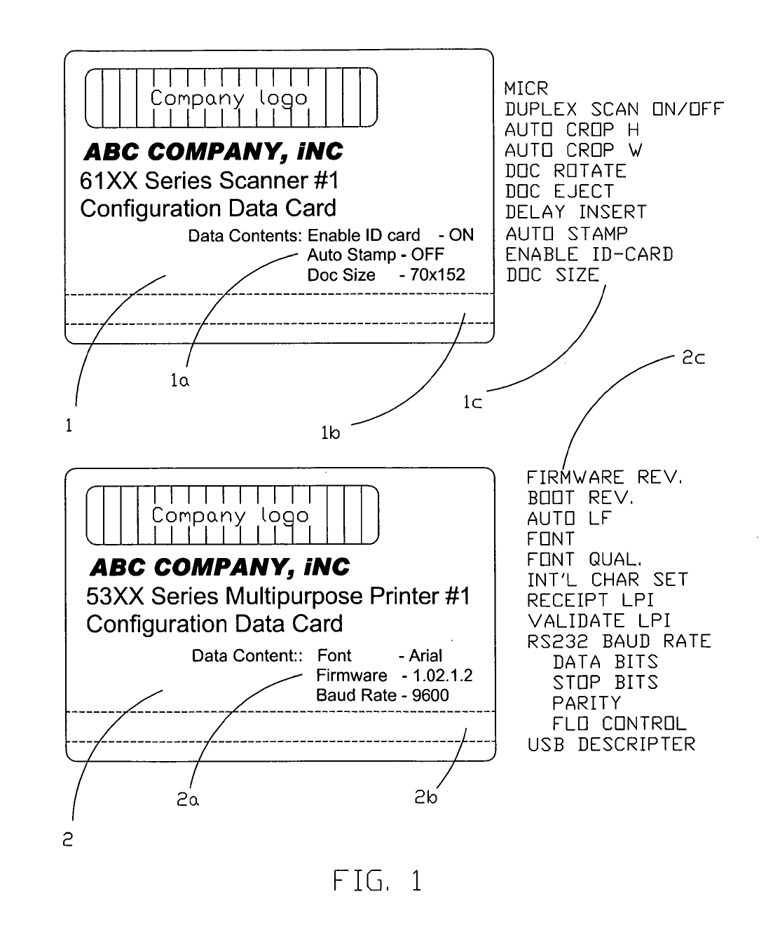

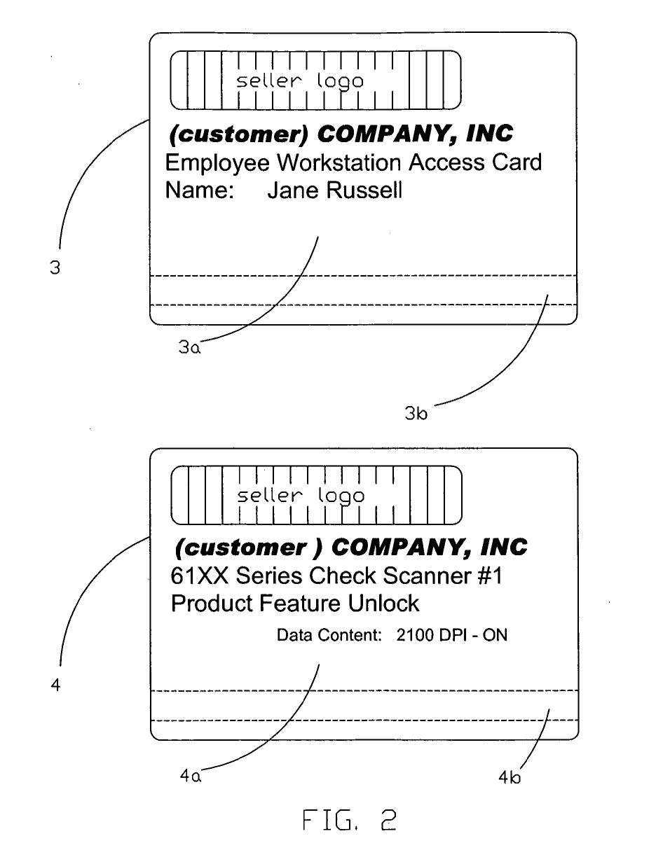

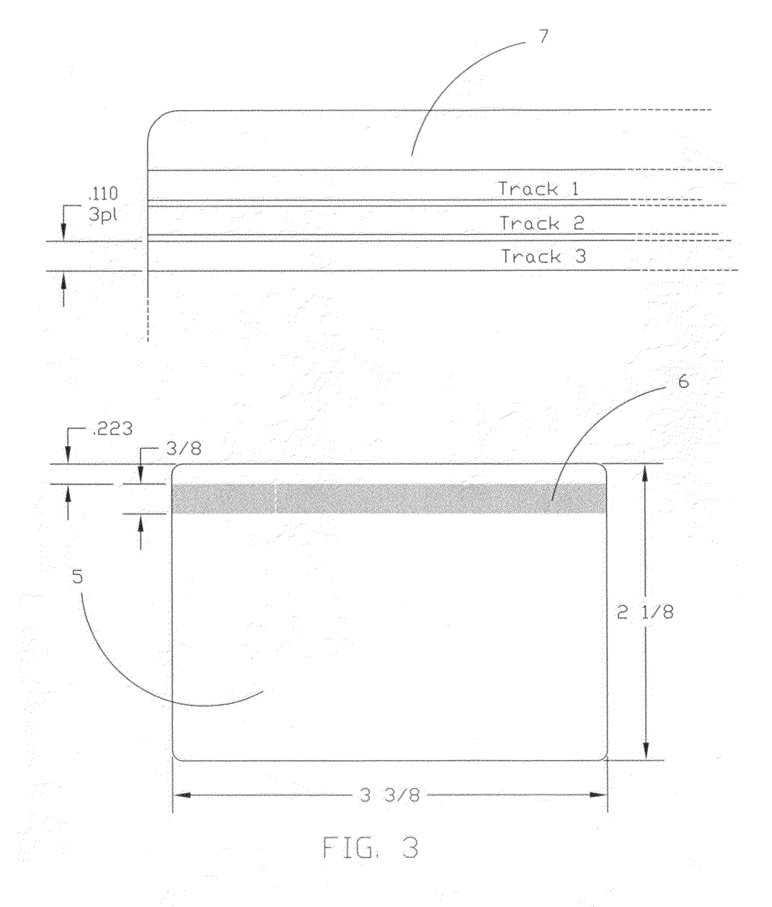

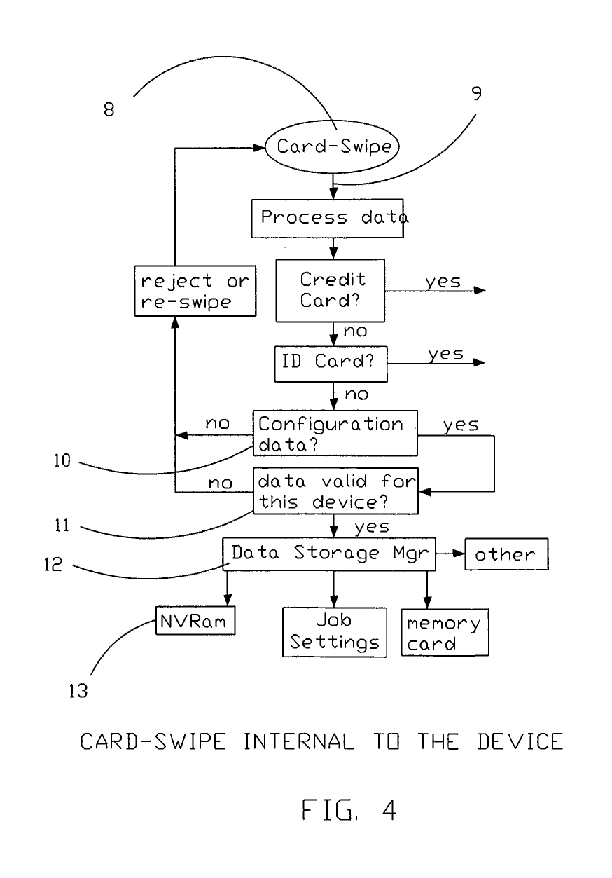

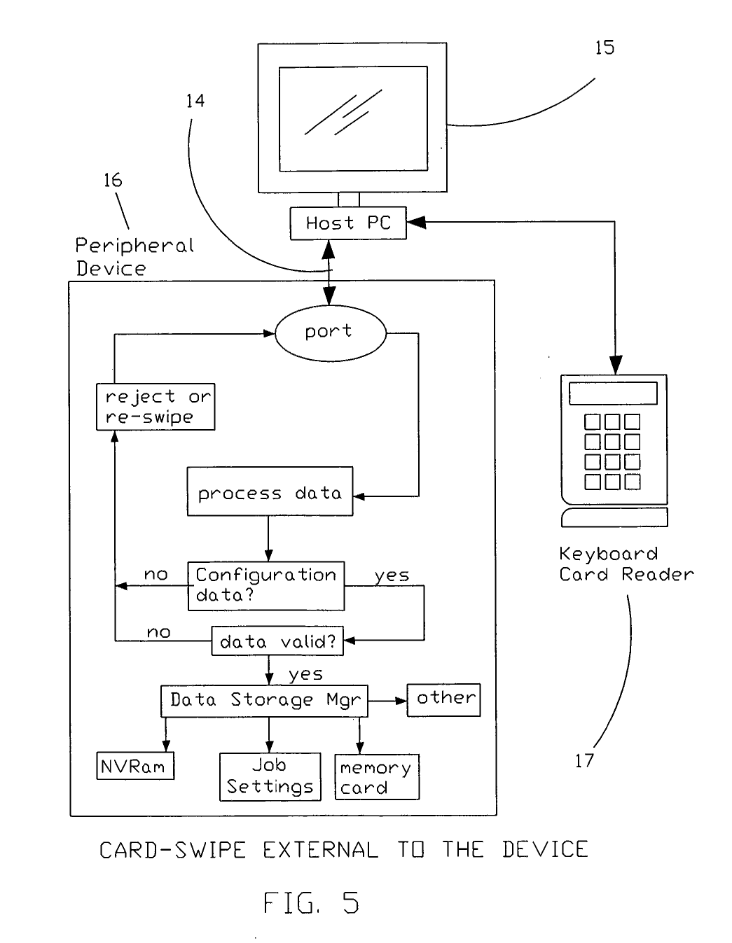

FIGS. 1 and 2 show magnetic-stripe plastic cards, front sides, with custom graphic layouts, unique to a user. The magstripe (1b,2b,3b,4b) is on the rear of the card, detailed in FIG. 3. Card 1 represents ABC Company's installed scanner #1 and the pre-programmed configuration changes la that will be programmed into the scanner when the card is swiped. Note that card data 1a lists only three of the many configuration parameters 1c that might be changed. The technology for creating, programming and reading magstripe cards is well known and will not be discussed in detail, except that, the supplier/programmer of the cards may be the peripheral device supplier, who would respond to requests from the user to change one or more of the configuration parameters. The technology is inexpensive, and the user may, indeed, acquire his own programming capability. The supplier-user relationship is not among the claims of this invention, however. Also, not detailed, is the software coding that embodies the block diagrams as in FIG. 4 and FIG. 5. Block-level description is sufficient to describe the method. FIG. 1, card 2, with configuration data 2a represents ABC Company's typical printer, again, with only three of the many configuration parameters 2c possible. FIG. 2, Card 3, with pre-programmed data 3a, represents another possible use of the magstripe card, that of allowing only a certain employee access to a peripheral device. FIG. 2, Card 4, with pre-programmed data 4a, shows yet another use, that of unlocking certain features of a device that might be requested and paid-for prior to the card being issued. FIG. 2, 4a shows, for example, a data-content (data-set) that enables high resolution 2100 DPI imaging.

Refer to FIG. 3. Unlike the custom graphics on the front of the card, the magstripe must conform to ISO/IEC standards 7810, 7811-4, & 7811-5 for size and stripe location in order to position the data on the card in conformance with read/write heads on standard card-readers. An all-important feature of this invention is the ability to utilize this described custom swipe card in the same equipment that accommodates credit/debit cards, ID cards, drivers licenses, which, are, indeed, manufactured to the aforementioned standards. In FIG. 3, several dimensions are shown on card 5 to clarify the important similarities required. The magstripe 6 is shown in an expanded view 7 to show tracks, 1,2 & 3. The serial sequence of data written to these tracks is specifically outlined in the aforementioned ISO/IEC standards for the credit/debit card industry. However, the configuration data in this invention, being entirely of different purpose, does not have to follow in any serial sequence. Additionally, the data may be written on any one or more of the tracks, depending on the data space required. In this invention the exampled scanner and printer may only require less than 500 bits of configuration-data space. Track 1 alone, using the common 210 bits-per-inch density, can easily accommodate that requirement.

On a configuration card the first piece of data visualized to be written is a unique digital identifier (several bits long) which, distinguishes the card as “configuration”. Next in the sequence, data will be written to identify the device being written to, maybe by serial number, network name, or IP address. Next, coded onto the stripe after the identifiers are specific configuration parameters separated by field separators as necessary. There may be just several parameters, as shown in FIG. 1, item 1a or 2a, or more.

In the preferred embodiment, FIG. 4, the card reader is part of the device itself, Note card-swipe 8 at the head of the device's internal software utility, most likely part of the firmware within the device, is block-diagrammed with the utility, and, data transfer between the reader and the device, be it a printer, scanner, is internal. The block diagram describes the data path from the card-swipe to memory storage. The bit-stream at 9 is processed and identified as a credit/debit card, ID card, or a configuration card 10. The data is forwarded to a validation routine 11. Non-valid or non-configuration data will be discarded or returned for re-swipe. Valid data goes to the data storage manager 12 which routes data to its proper location. NV Ram 13 is generally where configuration data is stored.

In another embodiment, FIG. 5, a portable card-reader 17 is connected to the peripheral device 16 indirectly through an optional PC. The data connections may be RS-232, USB, or even wireless. As shown, the card-reader 17 is found integrated into a pin-pad device. This embodiment is currently popular in point-of-sale (POS) systems in small retail establishments, and, is the equivalent of an electronic cash register. In this embodiment, a software utility is installed into the host PC 15 to recognize the swiped data as “configuration” data rather than “credit-card” data, or “gift-card” data, and, the data is routed accordingly to the peripheral device 16 through a RS-232, USB, or wireless port 14.

In still another embodiment, not illustrated, the PC 15 may be absent, in which case the card reader 17 would be connected to the peripheral 16 directly through a similar communications port.

In all discussed embodiments, three things are necessary: a) the peripheral device being reconfigured, b) a card-reader and, c) proper communication protocol between devices. With a PC present, simple RS-232 or USB connections would be adequate. In large networks consisting of a host, multiple workstations, and multiple peripheral devices, the reconfiguration of a peripheral is usually done en mass from a software application resident in the network host, but, could also be done with a card-swipe.

I claim:

1. A method for configuring or reconfiguring data in a configurable peripheral device by way of a magnetic stripe card, comprising:
a. selecting a data-set representing one or more parameters designed for a configurable peripheral device.
b. programming said data-set onto the magnetic stripe on a blank card.
c. swiping the programmed card through a compatible card reading device which is connected to the peripheral directly or indirectly through an available communications port.
d. the configurable device receiving the new data-set and acting upon it.

2. The method of claim 1, where the configurable peripheral device has an integral card-reader.

3. The method of claim 1, where the configurable peripheral device will accept a compatible, separate, and portable card-reader.

4. The method of claim 1, where a minimum of a card-reader and a configurable peripheral device, reside in a network environment.

5. The method of claim 4, where the network environment is a cellular network.

6. The method of claim 4, where the network environment is a local ethernet.

7. The method of claim 4, where the network environment is a wide-area network such as the internet.

8. The method of claim 4, where the network environment is a personal computer with connected configurable peripheral devices.

9. A method that facilitates security access control to a configurable peripheral device, by way of a magnetic stripe card, comprising:
a. selecting a password representing an individual, or group.
b. selecting a data-set representing one or more parameters that are of a secure nature.
c. programming the said password and data-set onto the magnetic stripe on a blank card.
d. swiping the programmed card through a compatible card reading device, which is connected to a configurable peripheral directly or indirectly thorough a communications port.
e. the configurable peripheral device receiving the new data-set and acting upon it.

10. The method of claim 9 where the security access to be gained is to lock or unlock features within the configurable peripheral device that are only available with special authorization.

11. The method of claim 9 where the security access to be gained is limited to an individual, or specific group.
